(19) United States
(12) Patent Application Publication
(10) Pub. No.: US 2009/0147543 A1
(43) Pub. Date: Jun. 11, 2009

(54) DC-DC CONVERTER FOR DISPLAY APPARATUS

(76) Inventors: Yoshihiko SUGAWARA, Yokohama (JP); Akihiko Kanouda, Hitachinaka (JP); Tetsunosuke Nakamura, Yokohama (JP); Kazunori Takahashi, Kanegasaki (JP); Teruaki Sato, Ichinoseki (JP); Takayuki Shindo, Yokohama (JP); Shinpei Yao, Yokohama (JP); Fusao Sakuramori, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/326,926

(22) Filed: Dec. 3, 2008

(30) Foreign Application Priority Data
Dec. 7, 2007 (JP) 2007-316530

(51) Int. Cl. H02M 3/22

(52) U.S. Cl. 363/16

(57) ABSTRACT

A DC-DC converter, which supplies a drive power to a display apparatus, includes a plurality of insulated transformers, a resonance capacitor, and a resonance coil. Primary coils of the plurality of insulated transformers, the resonance capacitor, and the resonance coil are connected in series to form a current resonance circuit, and secondary coils of the plurality of insulated transformers are connected in parallel.

### INCORPORATION BY REFERENCE

The present application claims priority from Japanese application JP 2007-316530 filed on Dec. 7, 2007, the content of which is hereby incorporated by reference into this application.

### BACKGROUND OF THE INVENTION

The present invention relates to a DC-DC converter and more particularly, to a technique for making the DC-DC converter thin.

As ones of techniques relating to the present invention, there are shown JP-A-2006-50689 and JP-A-2006-149016 as examples.

FIG. 2 shows an example of a prior art DC-DC converter circuit for a liquid crystal display apparatus which forms a current resonance circuit of a series connection having a leakage inductance of interior of an insulted transformer T3 and also having a capacitance of a primary-side series-connection resonance capacitor C3, with an improved power conversion efficiency.

In the drawing, Q1 and Q2 denote switching elements, IC1 denotes a control/drive integrated circuit, T3 denotes an insulated transformer, D1 and D2 denote secondary-side rectifying diodes, C3 denotes a current resonance capacitor, and C2 denotes a secondary-side filter capacitor. The leakage inductance of interior of the insulted transformer T3 and the capacitance of the primary-side series-connection resonance capacitor C3 form a series-connection current resonance circuit to increase a power conversion efficiency.

The insulated transformer includes primary and secondary windings or coils wound with loose coupling, a coupling coefficient k set at about 0.7, and an arrangement compatible with a wide range by way of reducing switching frequency variable range.

### SUMMARY OF THE INVENTION

As television tends to be made thin in both of liquid crystal and plasma types, it has been required to reduce the heights of components while maintaining a high efficiency and avoiding an increase in the surface area of a DC-DC converter circuit board.

With a single insulated transformer shown in FIG. 2 utilizing the leakage inductance of interior of the transformer; reduction of the height of the insulated transformer causes an increase in the core loss of a core of the insulated transformer and an increase in the copper loss of coil of the transformer. This results in increases in the temperatures of the coil and core of the insulated transformer, making it difficult to secure a reliability in the insulated transformer.

In view of the above respects in the prior arts, it is an object of the present invention to provide a DC-DC converter which can made low in height while eliminating the need for using an insulated transformer having a leakage inductance therein, with the result of a secured reliability and a minimized board surface area.

The above object is attained, for example, by inventions set forth in claims. Typical ones of inventions disclosed in the present application will be briefly explained as follows.

A converter in accordance with the present invention is a DC-DC converter which supplies a drive power to a display apparatus. The converter includes a plurality of insulated transformers, a resonance capacitor, and a resonance coil. Primary coils of the plurality of insulated transformers, the resonance capacitor, and the resonance coil are connected in series to form a current resonance circuit. The secondary-side windings of above plural insulated transformers are connected in parallel.

In accordance with the present invention, there can be provided a DC-DC converter which can make its height low while eliminating the need for using an insulated transformer having a leakage inductance therein, thus securing a reliability and avoiding an increase in the surface area of a board.

### BRIEF DESCRIPTION OF THE DRAWINGS

These and other features, objects and advantages of the present invention will become more apparent from the following description when taken in conjunction with the accompanying drawings wherein:

FIG. 1 is a circuit diagram of a DC-DC converter which supplies a drive voltage to a display apparatus in accordance with an embodiment of the present invention;

FIG. 2 is a known circuit diagram of a prior art insulated transformer which utilizes a leakage inductance of the transformer;

FIG. 3 is an equivalent circuit of a leakage inductance of the prior art insulated transformer;

FIG. 4 shows, in section, an example of an insulated transformer (a divided converter transformer) (of a lap winding type);

FIG. 5 shows, in section, an example of an insulated transformer (of a sectional winding type);

FIG. 6A shows an example of an insulated converter transformer having a coil-wound primary side;

FIG. 6B shows an example of an insulated converter transformer having a coil-wound secondary side;

FIG. 7 is an equivalent circuit diagram of an insulated converter transformer having a mutual inductance;

FIG. 8A shows an example of an outside view of an insulated converter transformer in accordance with an embodiment;

FIG. 8B shows an example of the transformer of FIG. 8A when viewed from a direction A in the same drawing;

FIG. 9A shows an example of an outside view of a resonance transformer in accordance with an embodiment of the present invention;

FIG. 9B shows an example of the transformer of FIG. 9A when viewed from a direction B in the same drawing; and

FIG. 10 shows an example of how to arrange insulated transformers of the present invention and a resonance transformer on a board.

### DESCRIPTION OF THE EMBODIMENTS

A DC-DC converter in accordance with the present invention is a DC-DC converter which supplies a drive power to a display apparatus. The converter includes a plurality of insulated transformers, a resonance capacitor, and a resonance coil. Primary coils of the plurality of insulated transformers, the resonance capacitor, and the resonance coil are connected in series to form a current resonance circuit. Secondary sides of the plurality of insulated transformers are connected in parallel with the current resonance circuit.

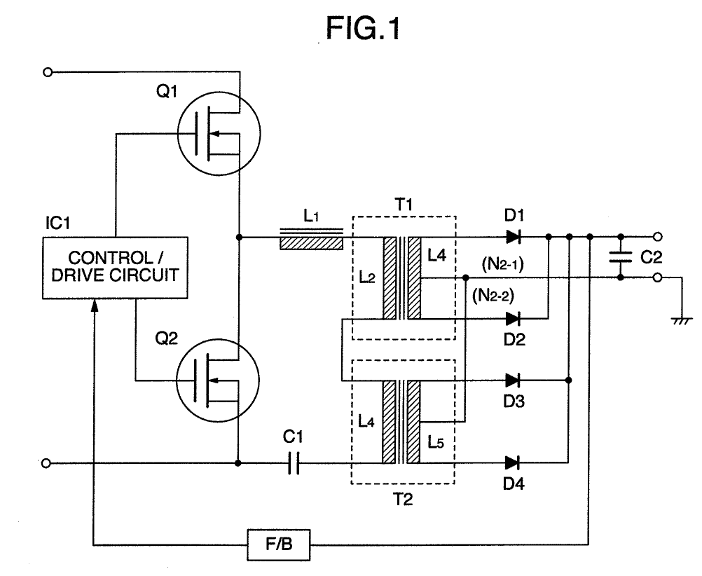

Explanation will be made in connection with an embodiment of a DC-DC converter in accordance with an embodiment of the present invention, by referring to the accompanying drawings. FIG. 1 is a circuit diagram of a DC-DC converter in accordance with an embodiment of the invention.

In FIG. 1, Q1 and Q2 denote switching elements, IC1 denotes a control/drive integrated circuit, T1 and T2 denote insulated transformers, D1 to D4 denote secondary-side rectifying diodes, C1 denotes a current resonance capacitor, and C2 denotes a secondary-side filter capacitor. The insulated transformers T1, T2, the resonance capacitor C1, and the resonance coil L1 are connected in series to form a current resonance circuit.

Although two of the insulated transformers are illustrated, the number of such insulated transformers can be set to exceed 2. Secondary sides of the plurality of insulated transformers T1, T2 are connected in parallel.

The switching element Q1 on a high side and the switching element Q2 on a low side are controlled under control of the control/drive circuit IC1 to be repetitively turned alternately ON and OFF with duty ratios of 50% and 50% respectively. An intermediate point of each of the secondary coils is grounded so that pulses of positive and reverse polarities are applied to the primary coils, thus increasing a conversion efficiency.

Since currents flowing though the switching elements Q1 and Q2 do not become zero when the switching elements Q1 and Q2 are turned ON and OFF, a thermal loss takes place and the efficiency of the converter is reduced.

In order to avoid the reduced efficiency, the resonance coil L1 and the resonance capacitor C2 are connected in series with the primary sides of the insulated transformers T1, T2 to form the current resonance circuit and to thus convert the waveforms of currents flowing through the primary sides of the insulated transformers into a sinusoidal waveform. As a result, the thermal loss upon the turning ON and OFF of the switching elements can be reduced and the efficiency of the converter can be increased.

Under control of the control/drive circuit IC1, the phase of a primary current of the insulated transformer T1 becomes minus when the high-side switching element Q1 is turned ON and slightly later, is changed to minus; whereas the primary current rises when the high-side switching element Q1 is turned OFF. In other words, switching (ZVS (Zero-Voltage Switching)) is carried out by detecting the fact that the voltage is changed to zero. Thus the thermal loss is reduced and the efficiency of the converter is increased.

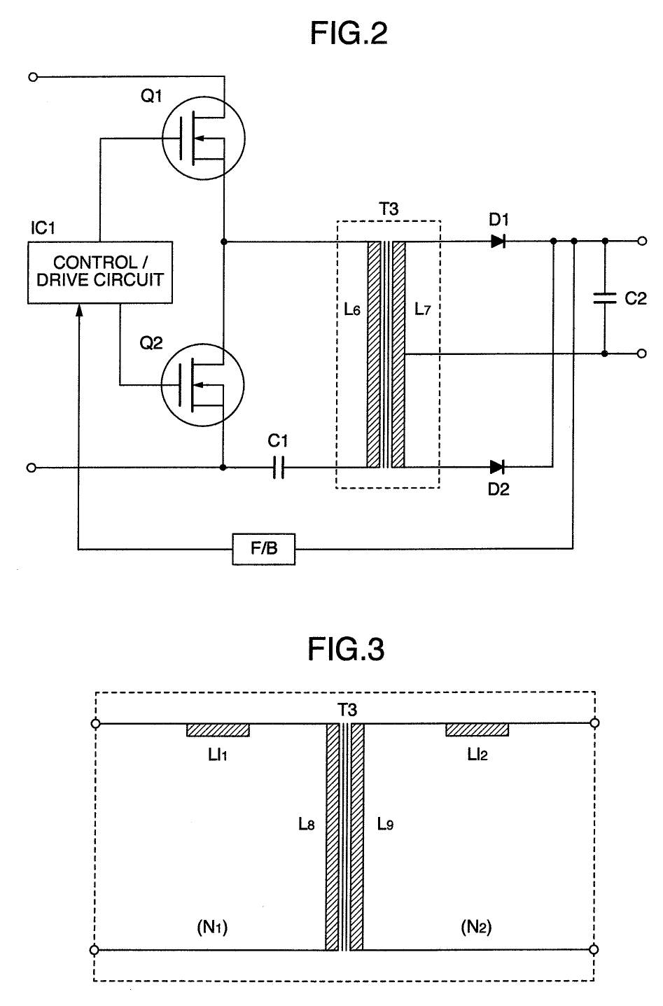

FIG. 3 is an equivalent circuit of the leakage inductance of the insulated transformer in FIG. 2.

Assume that the inductance of the primary coil of the insulated transformer is denoted by L₆, the inductance of the secondary side is denoted by L₇, a leakage inductance as viewed from the primary side is denoted by L_{ι1}, a leakage inductance as viewed from the secondary side is denoted by L_{ι2}, a coupling coefficient between the primary and secondary sides is denoted by k. Then, the leakage inductances as viewed from the primary and secondary sides and the coupling coefficient are expressed by equation (1) to (3) as follows.

k=1−(L_{ι1}/L₈) (1)

L_{ι1}=L₈(1−k) (2)

L_{ι2}=L₉(1−k) (3)

Wherein, (−1≦k≦1)

When the number of turns of the primary coil is denoted by N₁ and the number of turns of the secondary coil is denoted by N₂, the primary leakage inductance L_{ι1} is expressed by an equation (4) which follows.

L_{ι1}=L_{ι2}(N₁/N₂)² (4)

The coupling coefficient k is a quantity which largely depends on a geometrical position relationship between the both coils. Since an internal leakage inductance is determined by a structure based on the geometrical position relationship, its adjustment range is narrow. When a plurality of such insulated transformers are connected in series, the number of turns of the primary coil is proportional to an inverse of the number of connected transformers. Thus the leakage inductance becomes small and its adjustment range becomes narrow. To avoid this, when a plurality of insulated transformers are connected in series, a resonance coil is provided outside the insulated transformer to attain flexible adjustment of the leakage inductance.

When a plurality of insulated transformers are connected in series, a ratio of the inductance L1 of the external resonance coil to the primary inductance is adjusted to be in a range of 1:5 to 1:12.

When a plural number (n) of insulated transformers are connected in series, a peak voltage on the primary coil is reduced down to 1/n. Thus radiation noise from the insulated transformers is decreased down to (1/n)².

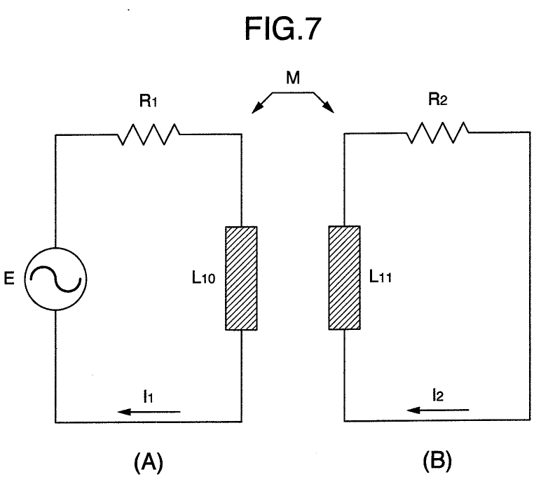

In FIG. 7, circuits (A) and (B) include an insulated transformer having a self inductance L₁₀ and an insulated transformer having a self inductance L₁₁ respectively, the circuits (A) and (B) are coupled each other with a mutual inductance M, and currents I₁ and I₂ flow through the circuits (A) and (B) respectively. In this case, relationships are satisfied and expressed by equations (5) and (6) which follow.

(R₁+ωL₁₀)I₁+jωMI₂=E (5)

jωMI₂+(R₂+jωL₁₁)^{I}₂=0 (6)

(Wherein, ω denotes an angular frequency and ω=2πf)

Finding the currents I₁ and I₂ according to the above equations results in equations (7), (8) and (9) which follow.

I₁=(R₂+jωL₁₀)E/{(R₁+jωL₁₀)(R₂+jωL₁₂)+ω²M²} (7)

I²=−jωME/{(R₁+jωL₁₀)(R₂+jωL₁₂)+ω²M²} (8)

M=k*(L₁₀*L₁₁)^{½} (9)

Assuming that the circuit (A), when the insulated transformer of the circuit (A) has a coupling coefficient, has a loss P_{(A)}, then an equation (10) is satisfied as follows.

P_{(A)}=(I₁−I₂)²*R₁ (10)

When a necessary power is supplied to the circuit (B), the smaller the coupling coefficient is the larger the loss of the equation (10) is. Thus, it is necessary to reduce the loss and decrease the coil temperature of the insulated transformer, by increasing the coupling coefficient to 0.95 or larger.

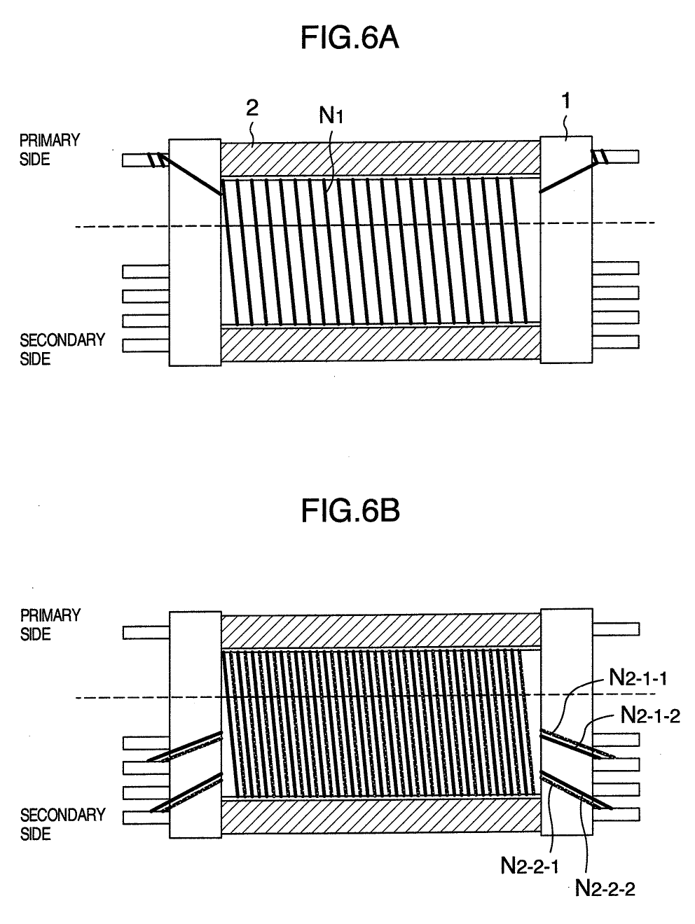

FIG. 5 shows a cross-sectional view of an insulated transformer having a leakage inductance therein. The coil bobbin has the grooves placed between a primary coil N1 and secondary coils N2-1, N2-2 to form a leakage inductance depends on a distance.

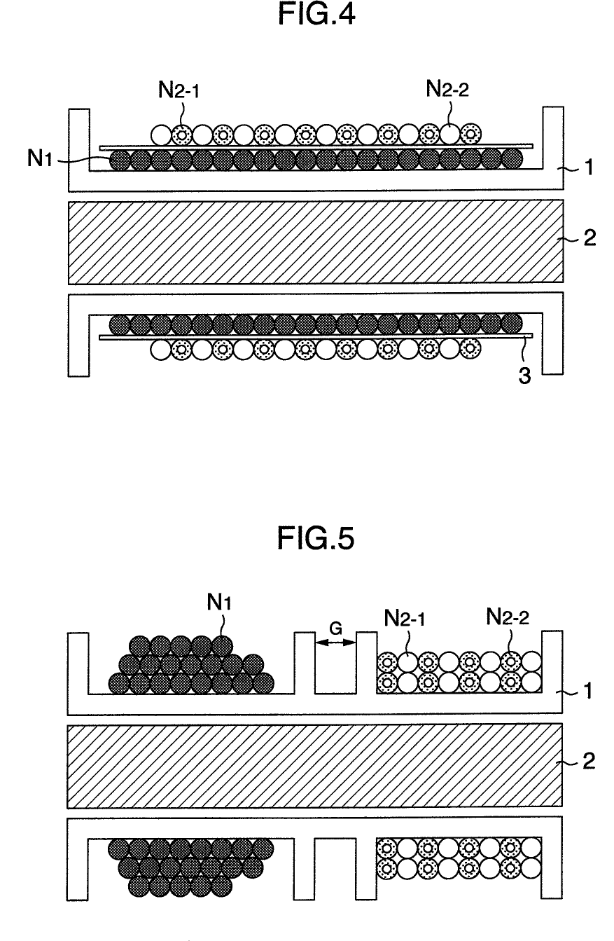

FIG. 4 shows an example of an insulated transformer when the primary coil N₁ and the secondary coils N₂₋₁, N₂₋₂ are wound around a core to be concentrically overlapped with each other, with a coupling coefficient of 0.95 or larger and with less loss. The overlapped winding enables the coil temperature of the insulated transformer to be reduced by a temperature of 8° C. to 11° C.

FIG. 6B shows an example of an insulated transformer when a secondary coil N₂₋₁₋₂ and a secondary coil N₂₋₂₋₂ having a polarity opposed to the coil N₂₋₁₋₂ and having the same coil turn thereas are wound around a coil bobbin 3 in a bi-filar winding. Since two pairs pairing with opposite polarity one another, have two wires connected in parallel with same polarity one another are simultaneously wound with a coil bobbin 1, the secondary coil can be wound in a single layer and the insulated transformer can have a height of 10 mm or lower.

The employment of the bi-filar winding enables a coupling degree or coefficient between the secondary coils to be increased to 0.98 or larger, and also enables a difference between the coil output voltages to be reduced, with balanced operation and a reduced ripple current.

FIG. 6A shows an example of an insulated transformer when the primary coils N₁ are wound around the coil bobbin.

When a triple-insulated wire is employed as the primary coil, an insulating system between the primary and secondary coils can be enhanced and the height of the insulated transformer can be made to be 10 mm or lower.

FIGS. 6A and 6B show the examples of the insulated transformers when the primary and secondary coils are wound around the coil bobbin 1 in one direction without any returning point on its way.

Since an intermediate connection part of the secondary coil is connected in the form of a substrate pattern and coil returning on the way is not carried out on the coil bobbin, the height of the insulated transformer can be made to be 10 mm or lower.

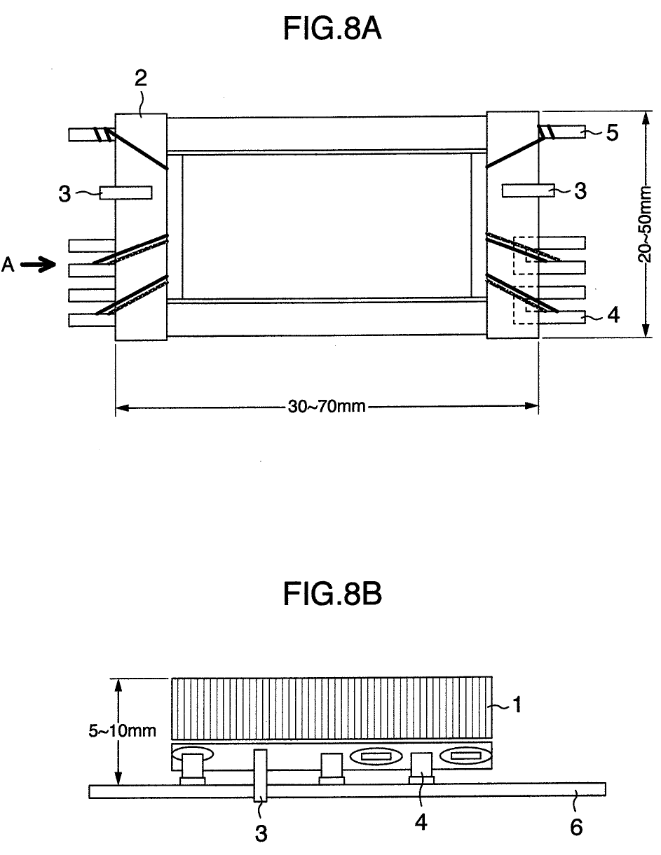

FIGS. 8A and 8B show an example of outside shape dimensions of an insulated transformer of the present invention.

In this case, the insulated transformer is set to have a height dimension not higher than 10 mm and not lower than 5 mm, a vertical dimension not lower than 20 mm and not higher than 50 mm, and a horizontal dimension not lower than 30 mm and not higher than 70 mm.

When the single insulated transformer is set to have an output power of 50W to 80W, the heat generation of the single transformer can be dispersed and the coil and core temperatures can be set at 105 degrees or lower.

In FIG. 8, a projection 3, which functions to isolate between a primary-side terminal 5 and a secondary-side terminal 4 and also to position the coil bobbin upon the mounting, is provided on a terminal mounting underframe 2 of a coil bobbin of an insulated transformer to thereby avoid an increase in the surface area of the circuit board.

FIGS. 8A and 8B show an example of outside shape dimensions of the resonance transformer of the present invention. In this case, the insulated transformer is set to have a height dimension not higher than 10 mm and not lower than 5 mm, a vertical dimension not lower than 20 mm and not higher than 50 mm, and a horizontal dimension not lower than 30 mm and not higher than 70 mm.

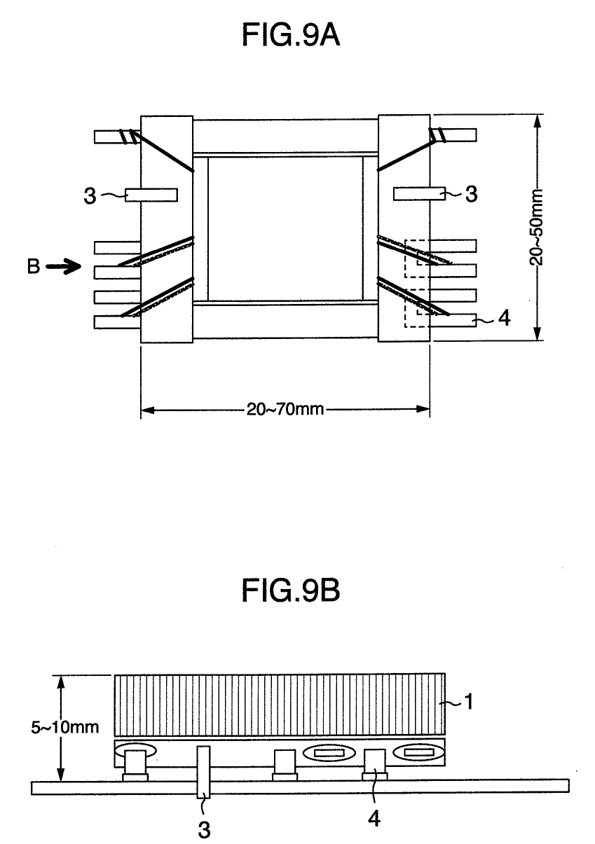

In FIGS. 9A and 9B, a secondary coil can be wound around one of secondary-side terminals, and the other terminal connected within a coil bobbin can be surface mounted in a flat plate shape.

Since a plurality of coils are used, the weight of each coil can be decreased and a weight applied to a pin terminal can be reduced, thus enabling the surface mounting.

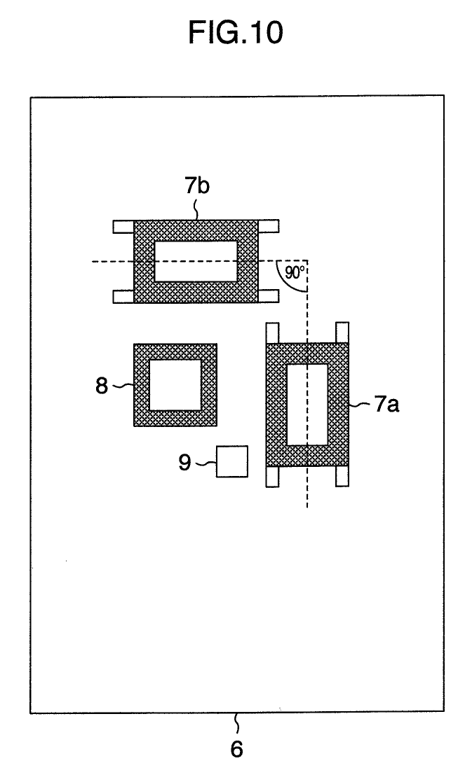

FIG. 10 shows an example when a resonance transformer is located next to either one of a plurality of insulated transformers.

One of the insulated transformers and the other insulated transformer are located so as to form an angle of 90 degrees, the resonance transformer is provided inside of the 90 degree angular range, so that the resonance transformer is located to one insulated transformer so as to minimize the surface area of their arrangement. Shortening the distances of each space between the transformers can reduce a pattern loss caused by a large current and can be avoided from becoming an oscillation source of noise caused by switching.

Although explanation has been made as to the DC-DC converter for a display apparatus in accordance with the embodiment of the present invention, the present invention is not limited to the aforementioned embodiment but may be varied in various ways in such a range as not to depart from the spirit and scope thereof.

As has been explained in the foregoing embodiment, the DC-DC converter according to the present invention includes the plurality of insulated transformers and the resonance capacitor, and the resonance coil; the primary coils of the plurality of insulated transformers, the resonance capacitor, and the resonance coil are connected in series to form the current resonance circuit; and the secondary coils of the plurality of insulated transformers are connected in parallel. As a result, a reliability can be secured without using an insulated transformer having a leakage inductance therein, and the height of the components can be made to be 10 mm or lower while avoiding an increase in the surface area of the board.

1. A DC-DC converter which supplies a drive power to a display apparatus, comprising:
a plurality of insulated transformers;
a resonance capacitor; and
a resonance coil,
wherein primary coils of said plurality of insulated transformers, said resonance capacitor, and said resonance coil are connected in series to form a current resonance circuit, and secondary coils of said plurality of insulated transformers are connected in parallel.

2. The DC-DC converter according to claim 1, wherein said insulated transformer has the primary and secondary coils concentrically wound around a core in a layer winding, a coupling coefficient between the primary- and secondary coils of said insulated transformer is 0.9 or larger.

3. The DC-DC converter according to claim 1, wherein said insulated transformer has the primary coil and the secondary coil having a polarity opposed to the primary coil and having the same coil turn thereas, the primary and secondary coils being wound in a bifilar winding manner, a coupling coefficient between the primary and secondary coils of said insulated transformer is 0.98 or larger.

4. The DC-DC converter according to claim 1, wherein said insulated transformer has the primary and secondary coils wound around a bobbin arranged in the same axis as a core in one direction without a returning point on the way.

5. The DC-DC converter according to claim 1, wherein said insulated transformer has the primary and secondary coils, at least the primary coil is wound using a triple-insulated wire.

6. The DC-DC converter according to claim 1, wherein said insulated transformer has, as its outside shape dimensions, a height not lower than 5 mm and not higher than 10 mm, a vertical dimension not lower than 20 mm and not larger than 50 mm, and a horizontal dimension not lower than 30 mm and not higher than 70 mm.

7. The DC-DC converter according to claim 1, wherein said single insulated transformer has an output power of 50 w to 80 w.

8. The DC-DC converter according to claim 1, wherein a vertical dimension of said insulated transformer is shorter than a horizontal dimension thereof, pairs of primary-side terminals and secondary-side terminals, and a projection functioning to isolate between the terminals and also to position a bobbin upon mounting are provided at each of vertical sides.

9. The DC-DC converter according to claim 1, wherein a vertical dimension of the insulated transformer is shorter than a horizontal dimension thereof, pairs of primary-side terminals and secondary-side terminals of a substantially C-shape are provided to each of vertical sides, and the insulated transformer is capable of being surface mounted on a board.

10. The DC-DC converter according to claim 1, wherein said resonance transformer has, as one of its outside shape dimensions, a height not lower than 5 mm and not higher than 10 mm, said height of the resonance transformer being substantially the same as the height of said insulated transformer.

11. The DC-DC converter according to claim 1, wherein said resonance transformer is located adjacent to some of said plurality of insulated transformers.
